(19) United States
(12) Patent Application Publication
(10) Pub. No.: US 2025/0206296 A1
(43) Pub. Date: Jun. 26, 2025

(54) VEHICLE

(71) Applicant: SUBARU CORPORATION, Tokyo (JP)

(72) Inventors: Ryota NAKAMURA, Tokyo (JP); junichi Motoyama, Tokyo (JP); Tsukasa Mikuni, Tokyo (JP); Yuto Aoki, Tokyo (JP); Takeshi Saito, Tokyo (JP)

(73) Assignee: SUBARU CORPORATON, Tokyo (JP)

(21) Appl. No.: 19/077,510

(22) Filed: Mar. 12, 2025

Related U.S. Application Data
(63) Continuation of application No. PCT/JP2023/038181, filed on Oct. 4, 2023.

(51) Int. Cl. B60W 30/09; B60R 21/01; B60R 21/0134; B60W 50/14; H04L 9/40

(52) U.S. Cl. CPC B60W 30/09; B60R 21/0134; B60W 50/14; H04L 63/0869; B60R 2021/01272; B60W 2050/146; B60W 2556/65

(57) ABSTRACT

A vehicle includes a group data obtainer, a travel data obtainer, a determiner, and a control processor. The vehicle includes a first vehicle. The travel data obtainer acquires travel data including at least data on activation of an occupant protection system from one or more second vehicles including a particular vehicle. The control processor performs a control adapted to secure safety of an occupant of the first vehicle, based on the travel data when the determiner makes a determination that the travel data has been acquired from the particular vehicle. The control processor performs a control to notify a driver who drives the first vehicle of the travel data when the determiner makes a determination that the travel data has been acquired from a vehicle other than the particular vehicle.

### CROSS-REFERENCE TO RELATED APPLICATIONS

This application is continuation of International Application No. PCT/JP2023/036181, filed on Oct. 4, 2023, the entire contents of which are hereby incorporated by reference.

### BACKGROUND

The disclosure relates to a vehicle.

In recent years, systems that communicate between vehicles and perform a vehicle control of an own vehicle based on travel data acquired from other vehicles have begun to be widely used.

For example, Japanese Unexamined Patent Application Publication (JP-A) No. 2004-145672 proposes a technique in which travel data, such as an image captured by a camera mounted on a preceding vehicle, is shared between multiple vehicles, and an appropriate travel control of an own vehicle is performed based on data that is unrecognizable from the own vehicle.

### SUMMARY

An aspect of the disclosure provides a vehicle including a group data obtainer, a travel data obtainer, a determiner, and a control processor. The group data obtainer is configured to acquire group data unique to the vehicle. The vehicle includes a first vehicle. The group data is generated when mutual authentication is established between a driver who drives the first vehicle and a driver who drives a particular vehicle. The first vehicle and the particular vehicle are associated with each other in the group data. The travel data obtainer is configured to acquire travel data including at least data on activation of an occupant protection system from one or more second vehicles including the particular vehicle. The determiner is configured to make a determination, based on the group data, as to whether the travel data has been acquired from the particular vehicle. The control processor is configured to perform a control of the first vehicle based on a result of the determination of the determiner and the travel data. The control processor is configured to perform a control adapted to secure safety of an occupant of the first vehicle, based on the travel data when the determiner makes a determination that the travel data has been acquired from the particular vehicle. The control processor is configured to perform a control to notify the driver who drives the first vehicle of the travel data when the determiner makes a determination that the travel data has been acquired from a vehicle other than the particular vehicle.

An aspect of the disclosure provides a vehicle including one or more processors and one or more memories communicably coupled to the one or more processors. The one or more processors are configured to: acquire group data unique to the vehicle, the vehicle including a first vehicle, the group data being generated when mutual authentication is established between a driver who drives the first vehicle and a driver who drives a particular vehicle, the first vehicle and the particular vehicle being associated with each other in the group data; acquire travel data including at least data on activation of an occupant protection system from one or more second vehicles including the particular vehicle; make a determination, based on the group data, as to whether the travel data has been acquired from the particular vehicle; perform a control of the first vehicle based on a result of the determination and the travel data; perform a control adapted to secure safety of an occupant of the first vehicle, based on the travel data when making a determination that the travel data has been acquired from the particular vehicle; and perform a control to notify the driver who drives the first vehicle of the travel data when making a determination that the travel data has been acquired from a vehicle other than the particular vehicle.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a vehicle according to one example embodiment of the disclosure.

FIG. 2 is a diagram illustrating a configuration of communication of the vehicle illustrated in FIG. 1.

FIG. 3 is a diagram illustrating travel data that is to be acquired by the vehicle illustrated in FIG. 1.

FIG. 4 is a diagram illustrating a configuration of a processor of the vehicle illustrated in FIG. 1.

FIG. 5 is a diagram illustrating group data that is to be acquired by the vehicle illustrated in FIG. 1.

FIG. 6 is a flowchart of a registration procedure of the group data that is to be acquired by the vehicle illustrated in FIG. 1.

FIG. 7 is a flowchart of a process to be performed by the vehicle illustrated in FIG. 1.

### DETAILED DESCRIPTION

In a technique disclosed in JP-A No. 2004-145672, due to difficulty in determining whether provided travel data is trustworthy data, a vehicle control may possibly be performed in accordance with received data even if, for example, data such as false data is transmitted from a malicious vehicle.

It is desirable to provide a vehicle that performs an appropriate vehicle control.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale.

Throughout the present specification and the drawings, elements having substantially the same function and configuration are denoted with the same reference numerals to avoid any redundant description. In addition, elements that are not directly related to any embodiment of the disclosure are unillustrated in the drawings.

### EXAMPLE EMBODIMENT

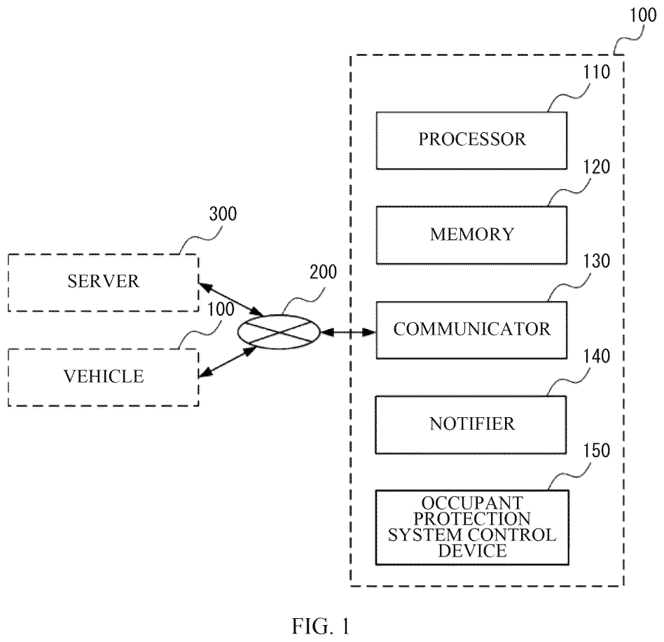

A vehicle 100 according to an example embodiment will be described with reference to FIGS. 1 to 7.
Configuration of Vehicle 100

As illustrated in FIG. 1, the vehicle 100 according to the example embodiment may include a processor 110, a memory 120, a communicator 130, a notifier 140, and an occupant protection system control device 150.

The processor 110 may acquire travel data from vehicles 100 coupled to a network 200 via the communicator 130. The processor 110 may acquire group data from a server 300 coupled to the network 200 via the communicator 130. The travel data and the group data will be described later. A configuration of the processor 110 will be described later.

The memory 120 may include a Read Only Memory (ROM) and a Random Access Memory (RAM), which are not illustrated. The memory 120 may store, for example, a control program and various kinds of data received from the processor 110.

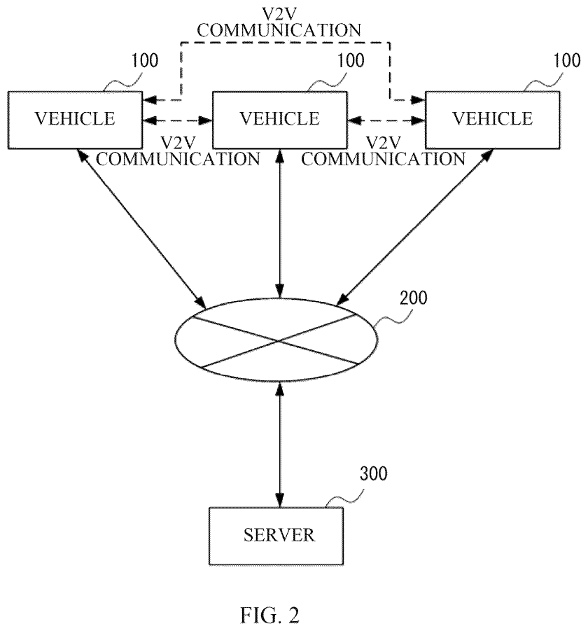

The communicator 130 may be a wireless communication module couplable to the network 200. The communicator 130 may communicate with the server 300 and at least one vehicle 100 via, for example, an Internet network. The communicator 130 may include, for example, a wireless communication module that performs vehicle-to-vehicle communication (V2V communication) as illustrated in FIG. 2. For the vehicle 100 configured to perform the vehicle-to-vehicle communication, the communicator 130 may transmit and receive travel data without using the network 200. Hereinafter, the vehicle 100 other than an own vehicle out of the vehicles 100 coupled to the network 200 will be referred to as “another vehicle”. In one embodiment, the own vehicle may serve as a “first vehicle”. In one embodiment, the other vehicle may serve as a “second vehicle”.

Non-limiting examples of the notifier 140 may include a display panel such as a liquid crystal display and a speaker. The notifier 140 may display a piece of display data received from the processor 110. The notifier 140 may output voice data received from the processor 110.

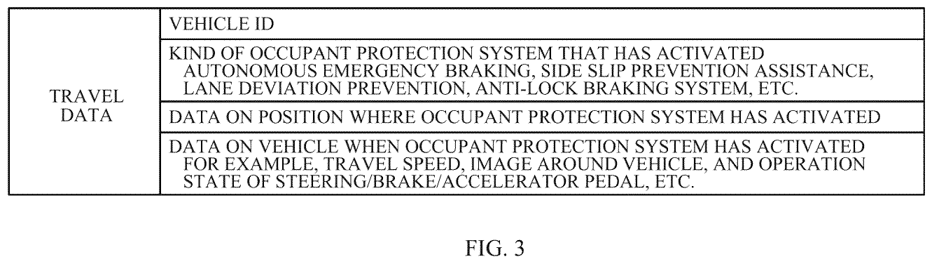

The occupant protection system control device 150 may control, for example, Advanced Driver-Assistance Systems (ADAS). The occupant protection system control device 150 may perform a vehicle control adapted to secure safety of an occupant, for example, based on data from various kinds of sensors disposed in the vehicle 100. Non-limiting examples of an occupant protection system to be controlled by the occupant protection system control device 150 may include autonomous emergency braking, side slip prevention assistance, lane deviation prevention, and anti-lock braking. In the example embodiment, when the occupant protection system has activated, the occupant protection system control device 150 may transmit travel data to other vehicles via the communicator 10 130. In some embodiments, the travel data may include at least data on activation of the autonomous emergency braking. As illustrated in FIG. 3, non-limiting examples of the travel data may include a vehicle identification (ID) of the vehicle 100 in which the occupant protection system has activated, the kind of the occupant protection system that has activated, data on a position where the occupant protection system has activated, and data on the 15 vehicle when the occupant protection system has activated. In the example embodiment, the occupant protection system control device 150 may perform the vehicle control adapted to secure the safety of the occupant in accordance with an instruction from the processor 110. The vehicle control to be performed by the occupant protection system control device 150 will be described later.
Configuration of Processor 110

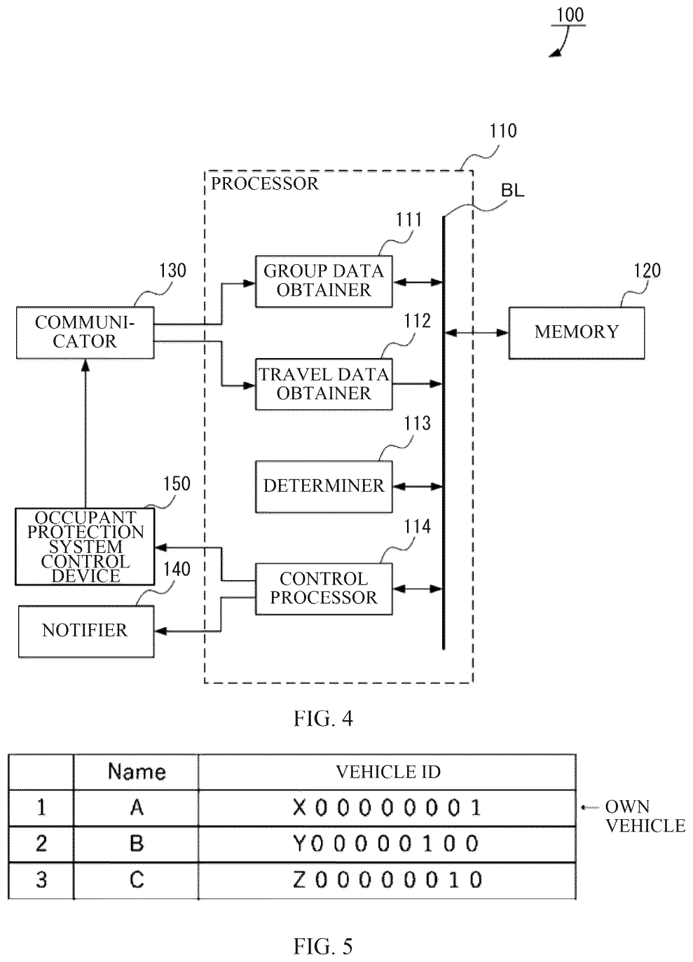

As illustrated in FIG. 4, the processor 110 may include a group data obtainer 111, a travel data obtainer 112, a determiner 113, and a control processor 114. The components of the processor 110 and the memory 120 may transmit and receive various kinds of data through a bus line BL. 25

The group data obtainer 111 acquires group data unique to the own vehicle and in which the own vehicle and a particular vehicle 100 are associated with each other. The group data is generated when mutual authentication is established between a driver who drives the own vehicle and a driver who drives the particular vehicle 100. In the example 30 embodiment, the group data obtainer 111 may acquire the group data unique to the own vehicle and in which the own vehicle and the particular vehicle 100 are associated with each other upon receiving an instruction from the control processor 114 to acquire the group data. The control processor 114 will be described later. In the example embodiment, the group data obtainer 111 may acquire the group data from the server 300 via the communicator 130. The group data may include, for example, data that associates a vehicle ID of the own vehicle with a vehicle ID of a vehicle driven by a person who is mutually trustworthy with the driver who drives the own vehicle. As illustrated in FIG. 5, the group data may include data in which, for example, the vehicle ID of the own vehicle is associated with vehicle IDs of vehicles driven by a person B and a person C who are mutually trustworthy with a person A who drives the own vehicle. The vehicles 100 coupled to the network 200 may each have group data unique to each vehicle. Drivers who drive the vehicles 100 may each register the group data in the server 300 in advance. A procedure of registering the group data in the server 300 will be described later. In the example embodiment, the group data obtainer 111 may transmit the acquired group data to the control processor 114, which will be described later, via the bus line BL.

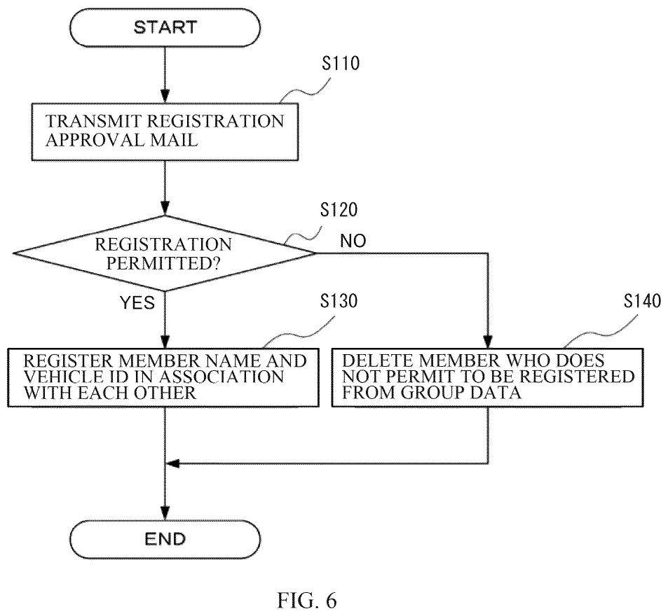

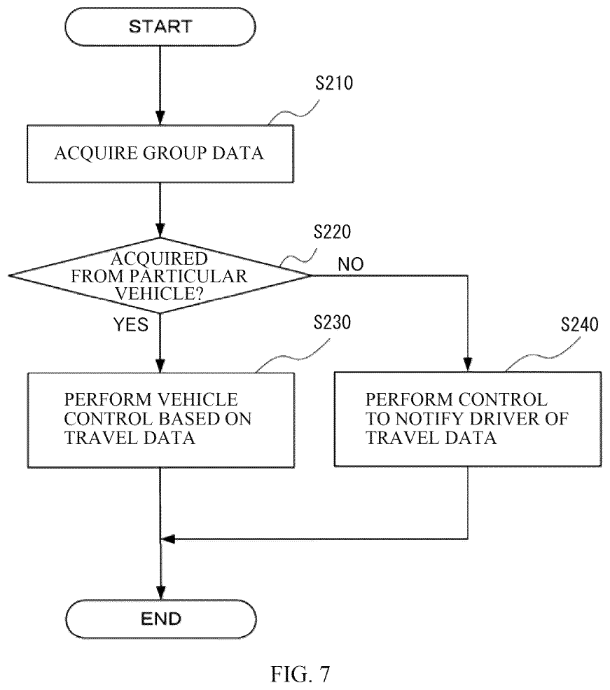

An example of the procedure for registering the group data in the server 300 will be described with reference to FIG. 6. When the person A who drives the vehicle 100 is to register the group data, for example, the person A registers, in the server 300, the vehicle ID of the own vehicle, names of the members, such as the person B and the person C, that the person A wishes to register in the group, and mail addresses of the members that the person A wishes to register using any device such as a portable terminal carried by the person A.

As illustrated in FIG. 6, the server 300 may transmit registration approval mails to the mail addresses registered by the person A (step S110). The server 300 may transmit the registration approval mails to obtain permission for registration to the group data from the members that the person A wishes to register in the group data. When the members (for example, the person B and the person C) who have received the registration approval mails permit the registration to the group data, each of the members may register, in the server 300, data indicating that the registration to the group data is permitted and a vehicle ID of the vehicle driven by the member who has received the registration approval mail. When the members (for example, the drivers B and C) who have received the registration approval mails do not permit the registration to the group data, each of the members may register, in the server 300, data indicating that the registration to the group data is not permitted.

The server 300 may determine whether the data indicating that the registration to the group data is permitted has been registered (step S120).

When it is determined that the data indicating that the registration to the group data is permitted has been registered (“YES” in step S120), the server 300 may register, to the group data, the name of the member who has permitted the registration and the registered vehicle ID in association with each other (step S130), and end the process.

When it is determined that the data indicating that the registration to the group data is not permitted has been registered (“NO” in step S120), the server 300 may delete, from the group data, the member who does not permit the registration (step S140), and end the process. Although the procedure for registering the group data has been described above, the procedure for registering the group data is not limited to the above-described procedure as long as it is possible to register the member who can be trusted by the person A to the group data. In some embodiments, the person A may register the name of a trustworthy member and the vehicle ID in the server 300. In this case, only the person A may be allowed to add members to be registered in the group data and to delete such members.

The travel data obtainer 112 acquires the travel data including at least data on activation of the occupant protection system from other vehicles including the particular vehicle 100. Non-limiting examples of the occupant protection system may include autonomous emergency braking, side slip prevention assistance, lane deviation prevention, and anti-lock braking. The travel data obtainer 112 may acquire the travel data from other vehicles including the particular vehicle 100 via the communicator 130. The travel data obtainer 112 may transmit the acquired travel data to the control processor 114, which will be described later, via the bus line BL.

The determiner 113 determines, based on the group data, whether the travel data has been acquired from the particular vehicle 100. In other words, the determiner 113 may determine whether the travel data has been acquired from the vehicle 100 driven by a trustworthy person. The determiner 113 may determine whether the travel data has been acquired from the particular vehicle 100, based on the group data and the travel data that are received from the control processor 114, which will be described later. The determiner 113 may determine whether the vehicle ID included in the received travel data is included in the group data. The determiner 113 may transmit a result of the determination to the control processor 114, which will be described later, through the bus line BL.

In the example embodiment, the control processor 114 may control an overall operation of the vehicle 100 in accordance with the control program stored in the memory 120. In the example embodiment, the control processor 114 may transmit, for example, an instruction to acquire the group data to the group data obtainer 111 to cause the group data obtainer 111 to acquire the group data. In the example embodiment, for example, the control processor 114 may transmit the group data to the determiner 113 and cause the determiner 113 to determine whether the travel data has been acquired from the particular vehicle 100. In the example embodiment, the control processor 114 controls the own vehicle based on the result of the determination received from the determiner 113 and the travel data received from the travel data obtainer 112. In the example embodiment, when the determiner 113 determines that the travel data has been acquired from the particular vehicle 100, the control processor 114 performs a control adapted to secure the safety of the occupant of the own vehicle, based on the travel data received from the travel data obtainer 112. For example, upon receiving, from the particular vehicle 100, the travel data indicating that the autonomous emergency braking has activated at 150 m ahead, the control processor 114 may transmit an instruction to the occupant protection system control device 150 to execute a control of winding up a slack of a seat belt of the own vehicle. For example, the control processor 114 may execute a control that causes the notifier 140 to notify the driver who drives the own vehicle of data indicating that the autonomous emergency braking has activated at 150 m ahead. The control processor 114 may transmit to the notifier 140, for example, a warning display such as the following: “The pre-tensioner of the seat belt will be activated due to detection of a vehicle in which the autonomous emergency braking has activated at 150 m ahead.” The control processor 114 may transmit a warning sound to the notifier 140 at the same time as the above-described warning display. When it is determined by the determiner 113 that the travel data has been acquired from a vehicle other than the particular vehicle 100, the control processor 114 performs a control to notify the driver who drives the own vehicle of the travel data received from the travel data obtainer 112. The control processor 114 may transmit to the notifier 140, for example, a warning display such as the following: “A vehicle in which the autonomous emergency braking has activated is detected at 150 m ahead. Please drive with caution.” The control processor 114 may transmit a warning sound to the notifier 140 at the same time as the above-described warning display.
Processing of Vehicle 100

A flow of processing when the control processor 114 receives the travel data from the travel data obtainer 112 will be described with reference to FIG. 7.

As illustrated in FIG. 7, the control processor 114 may transmit an instruction to the group data obtainer 111 to acquire the group data, and cause the group data obtainer 111 to acquire the group data (step S210).

The control processor 114 may transmit the group data and the travel data to the determiner 113 to determine whether the travel data has been acquired from the particular vehicle 100 (step S220). When the determiner 113 determines that the travel data has been acquired from the particular vehicle 100 (“YES” in step S220), the control processor 114 may cause the process to shift to step S230. When the determiner 113 determines that the travel data has been acquired from a vehicle other than the particular vehicle 100 (“NO” in step S220), the control processor 114 may cause the process to shift to step S240.

Based on the travel data received from the travel data obtainer 112, the control processor 114 performs a vehicle control adapted to secure the safety of the occupant (step S230), and end the process.

The control processor 114 may transmit the travel data received from the travel data obtainer 112 to the notifier 140 (step S240), and end the process.
Workings and Example Effects

As described above, the vehicle 100 according to the example embodiment includes the group data obtainer 111, the travel data obtainer 112, the determiner 113, and the control processor 114. The group data obtainer 111 acquires the group data unique to the own vehicle and in which the own vehicle and the particular vehicle 100 are associated with each other. The travel data obtainer 112 acquires the travel data including at least data on activation of the occupant protection system from other vehicles including the particular vehicle 100. The determiner 113 determines, based on the group data, whether the travel data has been acquired from the particular vehicle 100. The control processor 114 controls the own vehicle based on the result of the determination of the determiner 113 and the travel data. For example, the vehicle 100 may determine whether the travel data is acquired from the vehicle 100 driven by a person who is mutually trustworthy with the driver who drives the own vehicle. This helps the vehicle 100 to determine whether the travel data acquired by the travel data obtainer 112 is trustworthy data. The travel data includes at least data on activation of the occupant protection system. This helps the vehicles 100 in the group to share the data adapted to secure the safety of the occupants between the vehicles, allowing to perform an appropriate vehicle control based on the travel data.

When the determiner 113 determines that the travel data has been acquired from the particular vehicle 100, the control processor 114 of the vehicle 100 according to the example embodiment performs a control adapted to secure the safety of the occupant of the own vehicle, based on the travel data. In other words, the vehicle 100 may determine that the travel data received from the vehicle 100 driven by a trustworthy person is trustworthy data, and perform a vehicle control adapted to secure the safety of the occupant of the own vehicle, based on the received travel data. This helps the vehicle 100 to perform an appropriate vehicle control, allowing to secure the safety of the occupant of the own vehicle.

When the determiner 113 determines that the travel data has not been acquired from the particular vehicle 100, the control processor 114 of the vehicle 100 according to the example embodiment performs a control to notify the driver who drives the own vehicle of the travel data. In other words, the vehicle 100 may determine that the travel data received from a vehicle other than the vehicle 100 driven by a trustworthy person is not trustworthy data, and notify the driver of the received travel data. This helps the vehicle 100 to alert the driver.

In some embodiments, the travel data may include at least data on activation

of the autonomous emergency braking. For example, when the vehicle 100 receives data on activation of the autonomous emergency braking from the particular vehicle 100 that is trustworthy while traveling in the same direction as the particular vehicle 100 behind the particular vehicle 100, it is possible to activate the autonomous emergency braking of the own vehicle before a point where the autonomous emergency braking in the particular vehicle 100 has activated. This helps the vehicle 100 to secure the safety of the occupant of the own vehicle.

### Modification Example 1

In some embodiments, the vehicle 100 according to the example embodiment may perform a vehicle control to decelerate a speed of the own vehicle when the travel data received from the vehicle driven by a trustworthy person includes data on activation of the side slip prevention assistance or activation of the anti-lock braking. This helps the vehicle 100 to safely travel through a point where the occupant protection system has activated in another vehicle.

### Modification Example 2

In some embodiments, the driver who drives the vehicle 100 may register driver data such as the name and the vehicle ID in the server 300 in advance, and select a member from the driver data when registering the group data. This helps to easily select a mutually trustworthy member when the group data is to be registered in the server 300.

In some embodiments, it is possible to implement the vehicle 100 of the example embodiment of the disclosure by recording the process to be executed by the determiner 113 and the control processor 114 of the vehicle 100 on a non-transitory recording medium readable by a computer system, and causing the computer system to load the program recorded on the non-transitory recording medium onto the memory to execute the program. The computer system as used herein may encompass an operating system (OS) and a hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

The program may be directed to implement a part of the operation described above. The program may be a so-called differential file (differential program) configured to implement the operation by a combination of a program already recorded on the computer system.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art. The term “disposed on/provided on/formed on” and its variants having the similar meaning thereto as used herein refer to elements disposed directly in contact with each other or indirectly by having intervening structures therebetween.

The processor 110 illustrated in FIGS. 1 and 4 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 110. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 110 illustrated in FIGS. 1 and 4.

What is claimed is:

1. A vehicle comprising:
a group data obtainer configured to acquire group data unique to the vehicle, the vehicle comprising a first vehicle, the group data being generated when mutual authentication is established between a driver who drives the first vehicle and a driver who drives a particular vehicle, the first vehicle and the particular vehicle being associated with each other in the group data;
a travel data obtainer configured to acquire travel data comprising at least data on activation of an occupant protection system from one or more second vehicles comprising the particular vehicle;
a determiner configured to make a determination, based on the group data, as to whether the travel data has been acquired from the particular vehicle; and
a control processor configured to perform a control of the first vehicle based on a result of the determination of the determiner and the travel data, wherein
the control processor is configured to
perform a control adapted to secure safety of an occupant of the first vehicle, based on the travel data when the determiner makes a determination that the travel data has been acquired from the particular vehicle, and
perform a control to notify the driver who drives the first vehicle of the travel data when the determiner makes a determination that the travel data has been acquired from a vehicle other than the particular vehicle.

2. The vehicle according to claim 1, wherein the travel data comprises at least data on activation of autonomous emergency braking.

3. A vehicle comprising:
one or more processors; and
one or more memories communicably coupled to the one or more processors, wherein the one or more processors are configured to:
acquire group data unique to the vehicle, the vehicle comprising a first vehicle, the group data being generated when mutual authentication is established between a driver who drives the first vehicle and a driver who drives a particular vehicle, the first vehicle and the particular vehicle being associated with each other in the group data;
acquire travel data comprising at least data on activation of an occupant protection system from one or more second vehicles comprising the particular vehicle;
make a determination, based on the group data, as to whether the travel data has been acquired from the particular vehicle;
perform a control of the first vehicle based on a result of the determination and the travel data;
perform a control adapted to secure safety of an occupant of the first vehicle, based on the travel data when making a determination that the travel data has been acquired from the particular vehicle; and
perform a control to notify the driver who drives the first vehicle of the travel data when making a determination that the travel data has been acquired from a vehicle other than the particular vehicle.
